(19) United States
(12) Patent Application Publication
(10) Pub. No.: US 2004/0068428 A1
(43) Pub. Date: Apr. 8, 2004

(54) Management of business process application execution

(75) Inventor: Ian James Mitchell, Eastleigh (GB)

Correspondence Address: Gregory M. Doudnikoff, IBM Corp., IP Law Dept T81/503, 3039 Cornwallis Road, PO Box 12195, Research Triangle Park, NC, 27709-2195, US

(73) Assignee: International Business Machines Corporation, Armonk, NY

(21) Appl. No.: 10/385,888

(22) Filed: Mar. 11, 2003

(30) Foreign Application Priority Data
Oct. 2, 2002 (GB) 0222917.7

(51) Int. Cl. G06F 17/60; G06F 9/00; G06F 9/46

(52) U.S. Cl. 705/9; 719/328; 719/318

(57) ABSTRACT

A business process software application (5) is arranged to perform a composite business process (10) which includes a number of business function components (20, 30), each of which is executable in order to provide a business software function. The business process application uses a temporal layout manager (40) to instantiate an executor (50, 60) for managing the execution of the business function components, such that the business function components (20, 30) are executed in an order defined by a user via the temporal layout manager (40) in order to perform the composite business process (10). In this way complex event handling for the coordination of the business function components is achieved by a simplified user interface for the selection of those activities.

### FIELD OF THE INVENTION

This invention relates to computer applications that support or implement business processes and particularly but not exclusively to runtime facilities provided to execute such applications.

### BACKGROUND OF THE INVENTION

Business process applications are computer software applications that aim to integrate a number of management activities related to a business process, for example bank account management software. Typically an enterprise will have created application components for these activities, and the task of the business process application is to integrate these application components into a single process by sequencing and managing them. Known approaches to developing and executing such applications employ an event driven framework.

Implementing such applications involves defining the events that trigger activities and managing the execution of the activities in response to those events.

Enterprises expect the specification of overall business processes to be managed by ‘business analysts’ rather than ‘programmers’. This means that the development environment may be significantly different to that for programmers.

A first existing development methodology uses an Application Programming Interface (API) provided in a particular programming language (e.g., CICS Business Transaction Services).

A problem with this approach is that although it provides a high degree of flexibility (limited only by the programming language), it is complex. The API and development environment are more familiar to programmers than business analysts.

A second existing development methodology uses a graphical development tool that generates a description of the process that can be executed by a special piece of system software (an execution engine).

This approach is typically more useable for business analysts, but will be limited to the styles and types of function provided by the graphical tool and supported by the execution engine. Graphical representation of large or complex business processes can lead to unmanageable and useless diagrams.

A need therefore exists for temporal layout managers for business process applications wherein the above mentioned disadvantage(s) may be alleviated.

### SUMMARY OF THE INVENTION

In accordance with a first aspect of the present invention there is provided a temporal layout manager for business process applications as claimed in claim 1.

In accordance with a second aspect of the present invention there is provided a method for a temporal layout manager as claimed in claim 6.

In accordance with a third aspect of the present invention there is provided a computer program product for a temporal layout manager as claimed in claim 9.

Preferably the temporal layout manager has a graphical user interface for use by a user utilising the business process application. The graphical user interface preferably allows the user to determine the defined order of the execution of the business function components during execution of the business process application.

Preferably the defined order is parallel. Alternatively the defined order is sequential.

In this way a system, executor, method, computer program element and data carrier for business process applications is provided in which complex event handling for the coordination of the business function components is achieved by a simplified interface for the selection of those activities by a user during runtime.

### BRIEF DESCRIPTION OF THE DRAWINGS

One system, executor, method, computer program element and data carrier for business process applications incorporating the present invention will now be described, by way of example only, with reference to the accompanying drawings, in which:

FIG. 1 depicts diagrammatically a business process application incorporating a set of classes of a business process incorporating the present invention;

FIG. 2 is an object interaction diagram for sequential execution of elements of the business process application of FIG. 1; and

FIG. 3 is an object interaction diagram for parallel execution of elements of the business process application of FIG. 1.

### DESCRIPTION OF PREFERRED EMBODIMENT(S)

Layout managers are well known in the field of graphical application development. They provide an element of the application model and runtime implementation that relieves the developer from having to implement the detailed spatial arrangement of graphical components (e.g., text strings, selection boxes, menu items) on the screen. The developer can simply decide on the type of spatial arrangement required for a given set of components (e.g., tree, single column, multicolumn, or grid) and then select an appropriate layout manager to display them. This significantly raises the level of abstraction for the developer, and can enable a developer to carry out the task without the need to be familiar with the details of screen dimensions and pixels, whilst at the same time achieving results which are aesthetically acceptable and intuitive for the end users.

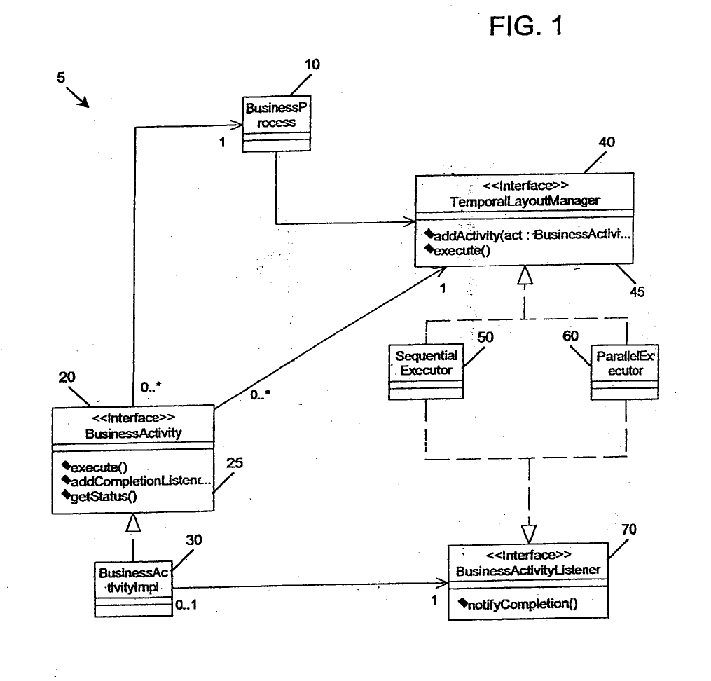

Referring to FIG. 1, there is shown a business process application system 5, comprising a set of process classes and their associated interactions.

A Business Process class 10 implements a composite business function or functions.

A Business Activity class 20 is a class that implements business functions 25. The Business Process class 10 uses a set of activities of the Business Activities class 20 to fulfil its responsibility, by specifying the methods required to allow composition of instances of business functions 25 to form the Business Process class 10.

A Business Activity lmpl 30 is a simple, empty instance of the Business Activity 20.

A Temporal Layout Manager 40 is an interface implemented by concrete temporal layout manager classes 45. These concrete classes provide particular behaviours—for example, sequential execution. The manager classes 45 manage the execution of the business activity class 20 A Sequential Executor 50 is a concrete Temporal Layout Manager class that implements sequential execution of the Business Activity class 20.

Similarly a Parallel Executor 60 is a concrete Temporal Layout Manager class that implements parallel execution of the Business Activity class 20.

A business Activity Listener 70 completes the system 5 by monitoring the activities of the business activity class 20 (or in this case, 30), and reporting these to the manager classes 45 (including the sequential and parallel executors 50 and 60 respectively).

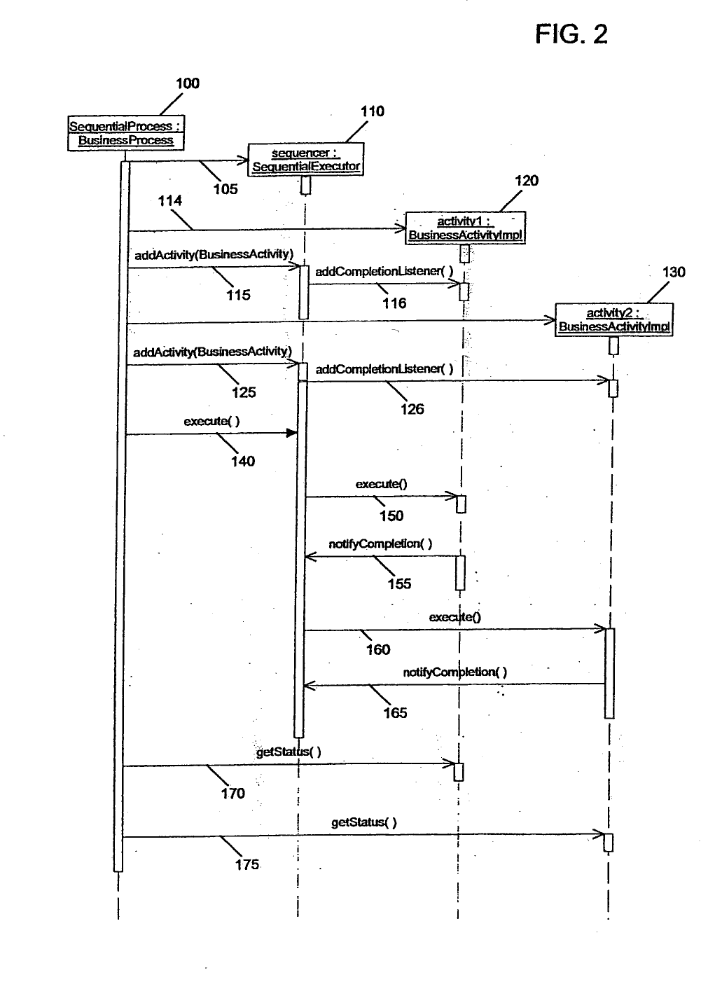

Referring now also to FIG. 2, there is shown a diagram of interactions for sequential execution of a business process using the system 5 of FIG. 1 as described above.

The business process of FIG. 2 is a composition of two business activities: a first activity 120 and a second activity 130. In FIG. 2 the second activity 130 is to execute after the first activity 120. The business process 100 constructs an instance (line 105) of a Sequential Executor 110 to which it will delegate the management of the execution of the first and second activities 120 and 130 respectively.

The first activity 120 is then instantiated by the business process 100 (line 114) and is made known to the Sequential Executor 120 (line 115), which then adds a completion listener for the activity 120 (line 116).

Similarly the second activity 130 is then instantiated by the business process 100 (line 124) and is made known to the Sequential Executor 120 (125), which then adds a completion listener for the activity 130 (line 126).

In this way the executor 120 has informed the first and second activities 120 and 130 respectively that it is to be notified of their completions.

The business process 100 then requests the Sequential Executor 120 to do its job (line 140) and it executes the first and second activities 120 and 130 respectively according to its defined strategy namely, sequentially. It invokes the execute method of the first activity 120 (line 150) and waits for notification of completion (line 155). Once this notification has been received, it invokes the execute method of the second activity 130 (line 160) and waits for notification of completion (line 165).

When the executor 110 has completed its job, the business process 100 examines the activities (lines 170 and 175) to determine their status.

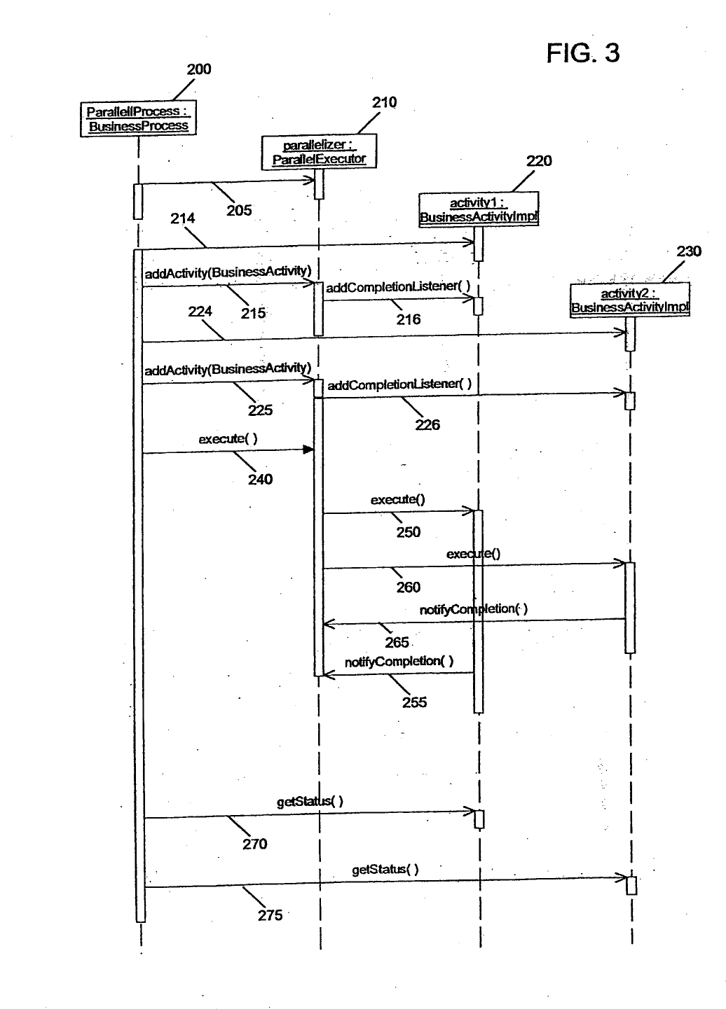

Referring now also to FIG. 3, there is shown Interactions for parallel execution are shown in FIG. 3. A business process 200 is the composition of first and second business processes 220 and 230 respectively using a Parallel Executor 210 as the layout manager.

The business process 200 constructs an instance (line 205) of the Parallel Executor 110 to which it will delegate the management of the execution of the first and second activities 220 and 230 respectively.

The first activity 220 is then instantiated by the business process 200 (line 214) and is made known to the Parallel Executor 220 (line 215), which then adds a completion listener for the activity 220 (line 216).

Similarly the second activity 230 is then instantiated by the business process 200 (line 224) and is made known to the Sequential Executor 220 (225), which then adds a completion listener for the activity 230 (line 226).

In this way the executor 220 has informed the first and second activities 220 and 230 respectively that it is to be notified of their completions.

The business process 100 then requests the Sequential Executor 220 to do its job (line 240) and it executes the first and second activities 120 and 130 respectively according to its defined strategy—namely in parallel. It invokes the execute method of the first activity 220 (line 250) and the execute method of the second activity 230 (line 260) and then waits for notification of completion of each (lines 255 and 265 respectively). Thus the Parallel Executor 210 invokes the execute method of the second activity 230 without waiting for completion of the first activity 220 and so allowing them to execute in parallel. This is all hidden from the business process 200.

When the executor 210 has completed its job, the business process 200 examines the activities (lines 270 and 275) to determine their status.

The difference in behaviour between FIG. 2 and FIG. 3 is the result of the differently implemented layout managers.

Additional behaviour can be easily incorporated into alternative layout managers. For example, a Sequential Conditional Executor may be implemented that proceeds to the next activity only if there has been no error so far. This is entirely encapsulated in the layout manager, the business process in each case simply picking the manager appropriate to its requirements.

It will be appreciated that the method described above for temporal layout management for business process applications may be carried out in software running on a processor (not shown), and that the software may be provided as a computer program element carried on any suitable data carrier (also not shown) such as a magnetic or optical computer disc.

This invention uses the concept of ‘layout managers’ to reduce the complexity of business process application systems. A temporal layout manager is chosen by a business process developer for a set of process components (i.e. the implementations of the activities that form parts of the process). This layout manager relieves the developer of the task of managing the execution of the components over time. The developer simply decides on the type of temporal arrangement required (e.g. sequential or parallel) and then selects the appropriate layout manager to employ in order to achieve this. Again the level of abstraction has been raised and the developer, who will typically be a business analyst, does not require advanced programming skills.

It will be understood that the temporal layout managers for business process applications described above provides the following advantages:

It provides a means to separate complex event handling for coordination of activities from simple selection of those activities. Furthermore it is easily extendible to any behaviour required by the application.

It will be understood by a person skilled in the art that alternative arrangements to those described above are possible. For example, as mentioned above the temporal layout managers include but are not limited to the sequential and parallel instantiations described above. Furthermore the number and nature of the business activities may differ from those described above.

1. A temporal layout manager for use with a business process application, the application being arranged to perform a composite business process derived from a plurality of business function components instantiated by the business process application, the temporal layout manager being instantiated by the business process application wherein the temporal layout manager is arranged to manage the execution of the plurality of business function components in a defined order such that the composite business process is performed.

2. A temporal layout manager of claim 1 wherein the temporal layout manager has a graphical user interface for use by a user utilising the business process application.

3. A temporal layout manager of claim 2 wherein the graphical user interface allows the user to determine the defined order of the execution of the business function components during execution of the business process application.

4. A temporal layout manager of claim 1 wherein the defined order is parallel.

5. A temporal layout manager of claim 1 inclusive wherein the defined order is sequential.

6. A method for a temporal layout manager to execute business process applications, the method comprising the steps of:
receiving a plurality of requests to execute a plurality of business function components in a defined order; and
executing each of the plurality of business function components in the defined order such that the composite business process is performed.

7. A method of claim 6 wherein the defined order is parallel.

8. A method of claim 6 wherein the defined order is sequential.

9. A computer program product, comprising instructions, which when executed on a data processing host cause said host to carry out a method of claim 6.
